(19) United States
(12) Patent Application Publication
(10) Pub. No.: US 2018/0325111 A1
(43) Pub. Date: Nov. 15, 2018

(54) ANTIBACTERIAL PARTICLES FUNCTIONALIZED WITH POLYALKYLENE IMINE AND ITS DERIVATIVES FOR WATER DISINFECTION

(71) Applicant: AGENCY FOR SCIENCE, TECHNOLOGY AND RESEARCH, Singapore (SG)

(72) Inventors: Yi Yan YANG, Singapore (SG); QingXing XU, Singapore (SG); Majad KHAN, Singapore (SG); Chuan YANG, Singapore (SG); Shrinivas VENKATARAMAN, Singapore (SG)

(21) Appl. No.: 15/773,993

(22) PCT Filed: Oct. 31, 2016
(86) PCT No.: PCT/SG2016/050535

§ 371 Date: May 4, 2018

(30) Foreign Application Priority Data
Nov. 4, 2015 (SG) 10201509091W

(51) Int. Cl. A01N 43/32; C02F 1/50; C08L 79/08

(52) U.S. Cl. CPC A01N 43/32; C08L 79/08; C02F 1/50

(57) ABSTRACT

This invention relates to an antibacterial polymer-modified particle comprising a particle core, wherein a polymer is covalently bound to the particle core via a linker and said polymer comprises a branched, amphiphilic cationic polyalkylene imine backbone having amine or amino functional groups and wherein optionally all or some of the amine or amino groups of the polymer have been further reacted with amphiphilic cyclic carbonates carrying a quaternary ammonium group under formation of a urethane bond. In a preferred embodiment the core is a silica core functionalized with the polyelkyleneimine. The invention also relates to methods of making such particles and their use in water disinfection applications.

### TECHNICAL FIELD

The present invention generally relates to polymer-modified particles as water disinfection means. The ability to disinfect water is achieved by chemical surface modification of the particles with polyalkylene imines and further modification with specific cyclic carbonate derivatives.

### BACKGROUND ART

Waterborne diseases are caused by pathogenic microbes that can be directly transmitted through contaminated water, and they can lead to adverse or sometimes fatal health consequences, particularly in immunocompromised populations. From 1971 to 2008 in the United States, there were 733 outbreaks reported in public water systems, resulting in 579,582 cases of illness and 116 deaths. Such outbreaks emphasize that microbial contaminants in drinking water remain a health-risk challenge and could amount to substantial socioeconomic impact. The primary sources of ground water contamination are septic tanks, cesspools, and leakage from municipal sewer systems and treatment lagoons, and the issue stems from the lack of or inadequate disinfection.

Conventional disinfection methods utilize free chlorine, chloramines and ozone that have proven to be effective for large-scale water treatment and prevented the outbreak of waterborne diseases. However, during the disinfection process, these chemical disinfectants can react with various constituents in natural water to form disinfection by products (DBPs), many of which have been found to be mutagenic or carcinogenic. Moreover, given the resistance of some pathogens, such as Cryptosporidium and Giardia, to conventional chemical disinfectants, extremely high disinfectant dosage is often required, leading to aggravated DBP formation. Although ultraviolet (UV) disinfection can avoid the production of undesirable DBPs, the technique is often limited due to its high operating cost, maintenance and energy consumption. Since UV light must be adsorbed into the microorganisms to achieve inactivation, anything that prevents the UV light from interacting with the microorganisms will impair disinfection. As a result, the efficiency of UV disinfection is dependent on the water quality and a post-disinfectant will often be required to maintain bacteriological integrity in the water system. Thus, there is a need to re-evaluate conventional disinfectants and to explore efficient, cost-effective and low-energy disinfection methods that avoid DBP formation.

There have been a number of studies focusing on developing permanent antimicrobial surfaces by covalently attaching cationic polymers, and many of which have demonstrated to kill air and/or waterborne bacteria. Among these cationic polymers, inexpensive and commercially available polyethylenimine (PEI) polymers containing quaternary ammonium groups alkylated with long alkyl or aromatic groups have been employed in applications, including nanoparticles and antibacterial coatings.

The previously reported micro particles are not fully satisfying in all regards. This relates to non-efficient immobilization on the material of the micro particle and related effectiveness or stability problems in any water disinfection methods. Many of the materials cannot be reused after their first application due to a lack of stability. There is therefore a need of a micro particle to which PEI is bonded in a way that the particles may exert strong and broad-spectrum antibacterial activity and reusability. There is further a need to improve the polyalkylene imine modified materials with regard to their effectiveness in combating bacteria of various types.

With this regard, PEIs chemically immobilized onto micro particle surfaces that eradicate bacteria via contact killing would be ideal for water disinfection due to their potential long-term stability, non-leaching property and environmental-friendliness. The micro particles would have the advantages of ease of dispersion and packing in continuous flow column applications, and ease of recovery and regeneration. Moreover, PEIs are relatively inexpensive.

There is still an increasing need for designing and developing antimicrobial materials for surfaces that aimed at offering effective antibacterial capabilities, while avoiding the use of disinfectants that pose potential risks of residual toxicity, environmental contamination, and promotion of bacterial resistance.

### SUMMARY OF INVENTION

According a first aspect of the invention an antibacterial polymer-modified particle is provided comprising a particle core, wherein a polymer is covalently bound to the particle core via a linker and said polymer comprises a branched, amphiphilic cationic polyalkylene imine backbone having amine or amino functional groups and wherein optionally all or some of the amine or amino groups of the polymer have been further reacted with amphiphilic cyclic carbonates carrying a cationic group under formation of a urethane bond.

Advantageously, the particles functionalized with the polyalkylene imine of suitable chain length and cyclic carbonates exert strong and broad-spectrum antibacterial activity. According to one embodiment the cationic backbone is a polyethylenimine (PEI) moiety with an average molecular weight range of about 1 kDa to about 30 kDa to ensure especially high disinfection activity. The particles may additionally have an ability to remove viruses.

An optional alternative to the main invention is provided wherein the polyalkylene imine particles are grafted with cationic amphiphilic cyclic carbonates. Advantageously, these embodiments provide further improvement of antibacterial activity of the particles. After acidification such particles eradicated S. aureus, P. aeruginosa and E. coli colonies completely at a low particle concentration of 10, 40 and 40 mg/mL, respectively, with significant improvement in antibacterial efficacy against E. coli.

According to a second aspect of the invention a method for making a polymer-modified particle is provided which comprises the steps of

a) grafting a polymeric backbone to a particle, which has been surface functionalized with a linker,
b) optionally reacting the product of step a) with an amphiphilic cyclic carbonate under ring opening to form a urethane bond and
c) acidifying the reaction product of step a) or b) with an acid to form the amphiphilic cationic backbone.

Advantageously, such method facilitates the functionalization of particles, such as silica particles, with branched polyalkylene imines. For instance, a propyl chloride group functionalized silica particle can be linked successfully to the amine group in the polyalkylene imine. Advantageously, the acidified particles show high activities against Gram-positive and Gram-negative bacteria.

According to a third aspect of the invention there is provided the use of the polymer-modified particles according to the invention for removing bacteria from an aqueous solution. The particles according to the invention are promising for water disinfection applications on a large scale while avoiding the need for chemical treatment.

According to a fourth aspect of the invention, there is provided the use of a polymer-modified particle according to the invention in water disinfection. Advantageously, the particles do not only have a use in such application due to their strong antibacterial efficacy, but the particles can be recycled and reused in a later disinfection without significant loss of activity. By using the same batch of particles, the antibacterial effectiveness was maintained in a repeated application.

### Definitions

The following words and terms used herein shall have the meaning indicated:

Those skilled in the art will appreciate that the invention described herein is susceptible to variations and modifications other than those specifically described. It is to be understood that the invention includes all such variations and modifications. The invention also includes all of the steps, features, compositions and compounds referred to or indicated in this specification, individually or collectively, and any and all combinations or any two or more of said steps or features.

As used herein, the term “polyalkylene imine” includes within its meaning a polymer with repeating unit composed of the amine group and multi carbon atom aliphatic alkylene (—CH₂—)ₓ spacers (with for instance x=2, 3, 4 etc.). “Polyethylenimine” (PEI) or polyaziridine accordingly includes within its meaning a polymer with a repeating unit composed of the amine group and a two carbon aliphatic (—CH₂CH₂—) spacer.

As used herein, the term “branched” polyalkylene imine or branched PEI refers to polyalkylene imine or PEI which contain at least one tertiary amino group in the polymer chains.

The term “antibacterial” refers to a capability of a material to destroy bacteria or suppresses their growth or their ability to reproduce.

The term “amphiphilic” refers to a capability of a molecule having both hydrophilic and hydrophobic parts.

The term “cationic” refers to molecule that comprises an ion or group of ions having a positive charge and characteristically moving toward the negative electrode in electrolysis. In the context of the instant invention the cationic group may specifically relate to a protonated ammonium group or a quaternary ammonium group in some embodiments.

As used herein, the term “alkyl” includes within its meaning monovalent (“alkyl”) and divalent (“alkylene”) straight chain or branched chain saturated aliphatic groups having from 1 to 6 carbon atoms, e.g., 1, 2, 3, 4, 5 or 6 carbon atoms. For example, the term alkyl includes, but is not limited to, methyl, ethyl, 1-propyl, isopropyl, 1-butyl, 2-butyl, isobutyl, tert-butyl, amyl, 1,2-dimethylpropyl, 1,1-dimethylpropyl, pentyl, isopentyl, hexyl, 4-methylpentyl, 1-methylpentyl, 2-methylpentyl, 3-methylpentyl, 2,2-dimethylbutyl, 3,3-dimethylbutyl, 1,2-dimethylbutyl, 1,3-dimethylbutyl, 1,2,2-trimethylpropyl, 1,1,2-trimethylpropyl and the like. Alkyl groups may be optionally substituted.

The term “aryl”, or variants such as “aromatic group” or “arylene” as used herein refers to monovalent (“aryl”) and divalent (“arylene”) single, polynuclear, conjugated and fused residues of aromatic hydrocarbons having from 6 to 10 carbon atoms. Such groups include, for example, phenyl, biphenyl, naphthyl, phenanthrenyl, and the like. Aryl groups may be optionally substituted.

The term “optionally substituted” as used herein means the group to which this term refers may be unsubstituted, or may be substituted with one or more groups other than hydrogen provided that the indicated atom's normal valency is not exceeded, and that the substitution results in a stable compound. Such groups may be, for example, halogen, hydroxy, oxo, cyano, nitro, alkyl, alkoxy, haloalkyl, haloalkoxy, arylalkoxy, alkylthio, hydroxyalkyl, alkoxyalkyl, cycloalkyl, cycloalkylalkoxy, alkanoyl, alkoxycarbonyl, alkylsulfonyl, alkylsulfonyloxy, alkylsulfonylalkyl, arylsulfonyl, arylsulfonyloxy, arylsulfonylalkyl, alkylsulfonamido, alkylamido, alkylsulfonamidoalkyl, alkylamidoalkyl, arylsulfonamido, arylcarboxamido, arylsulfonamidoalkyl, arylcarboxamidoalkyl, aroyl, aroyl-4-alkyl, arylalkanoyl, acyl, aryl, arylalkyl, alkylaminoalkyl, a group R^{x}R^{y}N—, R^{x}OCO(CH₂)ₘ, R^{x}CON(R^{y})(CH₂)ₘ, R^{x}R^{y}NCO(CH₂)ₘ, R^{x}R^{y}NSO₂(CH₂)ₘ or R^{x}SO₂NR^{y}(CH₂)ₘ (where each of R^{x} and R^{y} is independently selected from hydrogen or alkyl, or where appropriate R^{x}R^{y} forms part of carbocylic or heterocyclic ring and m is 0, 1, 2, 3 or 4), a group R^{x}R^{y}N(CH₂)ₚ— or R^{x}R^{y}N(CH₂)ₚO— (wherein p is 1, 2, 3 or 4); wherein when the substituent is R^{x}R^{y}N(CH₂)ₚ— or R^{x}R^{y}N(CH₂)ₚO, R^{x} with at least one CH₂ of the (CH₂)ₚ portion of the group may also form a carbocyclyl or heterocyclyl group and R^{y} may be hydrogen, alkyl. In this substituents all alkyl and aryl groups etc. are of the type defined above.

As used herein, the term “about”, in the context of concentrations of components of the formulations, typically means+/−5% of the stated value, more typically +/−4% of the stated value, more typically +/−3% of the stated value, more typically, +/−2% of the stated value, even more typically +/−1% of the stated value, and even more typically +/−0.5% of the stated value.

Throughout this disclosure, certain embodiments may be disclosed in a range format. It should be understood that the description in range format is merely for convenience and brevity and should not be construed as an inflexible limitation on the scope of the disclosed ranges. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Certain embodiments may also be described broadly and generically herein. Each of the narrower species and subgeneric groupings falling within the generic disclosure also form part of the disclosure. This includes the generic description of the embodiments with a proviso or negative limitation removing any subject matter from the genus, regardless of whether or not the excised material is specifically recited herein.

### DETAILED DISCLOSURE OF EMBODIMENTS

Non-limiting embodiments of the invention will be further described in greater detail by reference to specific examples, which should not be construed as in any way limiting the scope of the invention.

According to a first aspect, there is provided an antibacterial polymer-modified particle comprising a particle core, wherein a polymer is covalently bound to the particle core via a linker and said polymer comprises a branched, amphiphilic cationic polyalkylene imine backbone having amine or amino functional groups and wherein optionally all or some of the amine or amino groups of the polymer have been further reacted with amphiphilic cyclic carbonates carrying a cationic group under formation of a urethane bond.

The particle is “polymer-modified” by chemically binding a branched, amphiphilic polyalkylene imine polymer to the particle via a linker. The branched, amphiphilic polyalkylene imine backbone polymer forms a shell around the particle core. The backbone comprises cationic moieties, such as ammonium groups with a positive charge.

According to one embodiment of the invention the number of cationic groups can be increased by treatment of the particle with an acid to transform more amine groups into protonated ammonium groups. A suitable degree of cationic groups shown by a high surface [N⁺]/[N] ratio may be obtained by acidification. Acidified polymer-modified particles with a surface [N⁺]/[N] ratio >0.5, preferably between 0.5 and 0.9, measured by XPS as explained in the working examples may be specifically mentioned as highly active anti-microbials. However, particles obtained after reaction with the cyclic carbonates may already be highly effective at a Surface [N⁺]/[N] ratio of >0.3, preferably 0.3 to 0.8. Aqueous acid solutions can be used for acidification. Diluted aqueous mineral acids can be mentioned as suitable acids, such as HCl or H₂SO₄. After this acidification treatment particles according to the invention with increased cationic groups and high anti-bacterial capability can be obtained.

The particle core can be of any particle material that can be covalently bound to a suitable linker molecule. According to one embodiment the particle core is a silica particle. The particle core may have a size of about 0.1 μm to 1 cm, preferably 40 μm to 1 cm. According to an embodiment the particle is a micro particle of a size of about 0.5 μm up to 500 μm in diameter. Preferably the size is about 1 μm to 200 μm and, most preferably about 10 μm to 100 μm. Particle core diameters of about 1, 20, 40, 60, 80, 120, 200 μm can be particularly mentioned. The particle core and also the final particle may be a porous material with pore sizes of 10 to 100 Å.

The polyalkylene imine backbone polymer may be any polymer that contains a polyalkylene imine moiety as the main chain of the polymer. This main chain is branched. The alkylene moiety of the repeating unit may be a linear C₂ to C₄-alkylene chain. The polyalkylene imine backbone is preferably a polyethylenimine (PEI). The polyalkylylene imine may be linked to the linker via one of its amino or amin groups.

The polyalkylene imine or PEI backbone may have an average molecular weight determined by light scattering (LS) of about 0.1 to 800 kDa. Preferably the average molecular weight is about 1 to 30 kDa. Specific ranges that can be mentioned include about 0.5 to 40 kDa, about 0.5 to 40 kDa, about 1.5 to 10 kDa, about 1.7 to 7 kDa, about 1.8 to 5 kDa. According to one preferred embodiment the average molecular weight is about 1.2 to 3 kDa.

It is emphasised that the that the polyalkylene imine polymer bound to the particle does not need to be further alkylated to active. Pure polyalkylene imines may be used.

If PEI is used, the backbone may be also represented in general by the following formula (IV) without having exactly this structure:

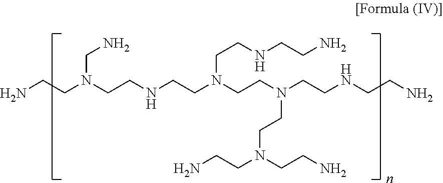

In this case Mₙ may be 1,000 to 70,000, preferably 1,500 to 10,000. It is most preferably 1,600 to 2,500.

The linker is a chemical compound that is bound to the particle core and to the branched polyalkylene imine polymer. In this way it links the particle core and the shell by covalent bonding. The linker may be covalently bound to the cationic polymer backbone via an amine bridge. For this amine bridge one of the amino groups of the polyalkylene imine may have been used. In case of a silica particle core the linker may be bound to this core by silyloxy bonds. The linker maybe an optionally substituted alkyl moiety. It may preferably be a propyl group.

According to the optional embodiments of the invention all or some of the amine or amino groups of the polymer have been further reacted with amphiphilic cyclic carbonates carrying a quaternary ammonium group under formation of a urethane bond. This embodiment is an optional modification of the particles according to the invention.

The optional urethane bond linked unit may be achieved by reaction with a cationic amphiphilic cyclic carbonate. The hydrophobic part of the carbonate may be an alkylene, alkylarylalakyl or alkylarylalkyl moiety. The hydrophilic part may be a cationic group. The cyclic carbonate may be a substituted cyclic alkylene carbonate, such as substituted trimethylene carbonate (TMC). It may be a derivative of methyl trimethylene carbonate (MTC). The substituents of the alkylene carbonate may carry quaternary ammonium groups as cationic groups. The quartenary ammonium groups may be linked by alkylene, alkyaryl, arylalkyl or alkylarylalkyl linkers bound via a C(═O)—O— group to the cyclic carbonate which may be optionally substituted with other substituents, such as for instance alkyl. The moieties of the quaternary ammonium group may further be alkyl or arylalkyl substituents.

In the final particle 25 to 65%, preferably 35 to 55% of the primary amine groups of the particle grafted polyalkylene imine may functionalized with the urethane bond linked unit.

The optional urethane bond linked unit may be represented by general formula (Ia) or formula (Ib):

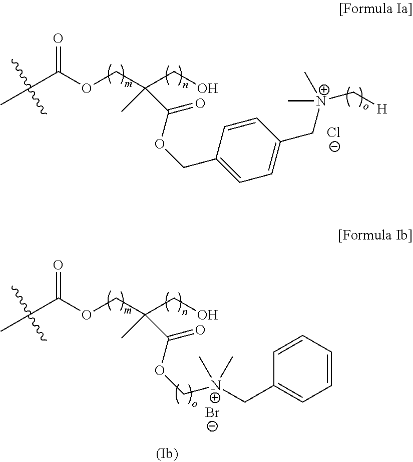

wherein
m is an integer selected from 0, 1 or 2;
n is an integer selected from 0, 1 or 2; and
o is an integer selected from 4 to 16.

The group of formula (Ia) or (Ib) is accordingly bond to an amine unit in the polymer forming the urethane bond.

In formula (Ia) or (Ib) m may be preferably 1. n may be preferably 1. o may be preferably 6 to 16. o may be chosen freely from any value such as 5, 6, 7, 8, 9, 10, 11, 12, 13, 14, 15 or 16.

A moiety of formula (Ia) wherein o is selected from 6 to 8 may be particularly mentioned.

According to a second aspect of the invention a method for making the polymer-modified particle is provided comprising the steps of

a) grafting a branched, amphiphilic cationic polyalkylene imine backbone polymer to a particle, which has been surface functionalized with a linker,
b) optionally reacting the product of step a) with an amphiphilic cyclic carbonate under ring opening to form a urethane bond and
c) acidifying the reaction product of step a) or b) with an acid to form the amphiphilic cationic backbone.

Step a) is a typical grafting step wherein the polymer is covalently bound to the particle via the linker functionalization. The polyalkylene imine backbone may be any polymer that contains a polyalkylene imine moiety as the main chain of the polymer. It may also be a non modified polyalkylene imine polymer. The polyalkylene imine polymer is branched. The branched, amphiphilic cationic polyalkylene imine backbone polymer can be a branched polyalkylene imine wherein the alkylene moiety may be a linear C₂ to C₄-akylene chain. This polyalkylene imine may be a branched polyethylenimine (PEI) according to certain embodiments of the invention.

The polyalkylene imine or PEI used as branched, amphiphilic cationic backbone polymer in step a) may have an average molecular weight determined by light scattering (LS) of about 0.1 to 800 kDa. Preferably the average molecular weight is about 1 to 30 kDa. Specific ranges that can be mentioned include about 0.5 to 40 kDa, about 0.5 to 40 kDa, about 1.5 to 10 kDa, about 1.7 to 7 kDa, or about 1.8 to 5 kDa. According to one preferred embodiment the average molecular weight is about 1.2 to 3 kDa. If PEI is used, the backbone may be also represented in general by the following formula (II) mentioned above for the first aspect of the invention.

The polyalkylene imine backbone polymers are either commercially available materials (e.g. from Sigma-Aldrich) or can be made according to known polymerization methods.

The particle to which the polymer is grafted may be a functionalized particle of any material that can be covalently bound to a suitable linker molecule. According to one embodiment the particle is a silica particle.

The particle may have a size of 0.1 μm to 1 cm, preferably 40 μm to 1 cm. According to an embodiment the particle is a micro particle of a size of about 0.5 μm up to 500 μm in diameter. Preferably the size is about 1 μm to 200 μm and, most preferably about 10 μm to 100 μm. Particle core diameters of about 1, 20, 40, 60, 80, 120, 200 μm can be particularly mentioned. The particle may be a porous material with pore sizes of 10 to 100 Å. Preferred particle sizes in mesh are 70 to 1000 mesh, preferably 200 to 500 mesh, most preferably 200 to 400 mesh.

According to one embodiment the particle is a functionalized silica particle. Such particles are commercially available or can be made according to known methods from commercially available functionalization reagents for silica. Typical functional materials and reagents for functionalization are for instance available from Sigma-Aldrich. The silica may be functionalized with an alkyl halogen or an optionally halogenated carboxylic acid moiety which are bound to the silica via silyloxy bonds. Functionalization with a propyl chloride or propyl bromide group may be mentioned. The following functionalized silica materials that can for instance react with an amino group of the polyalkylene imine backbone polymers can be particularly mentioned are 3-chloropropyl- or 3-bromo-propyl-functionalized silica gel, 3-carboxypropyl-functionalized silica gel, 4-benzylchloride-functionalized silica gel or propionylchloride-functionalized silica gel.

The functionalized silica can also be prepared by known silanisation methods of the surface hydroxyl groups on amorphous silica gels with suitable reagents. Such functionalization reagents include 3-chloropropyltrimethoxysilane, 3-chloropropyltriethoxysilane, etc.

Typical loading rates of the functionalized silica with the linker groups are about 0.1 to 10%, preferably about 1 to 4% and most preferably about 1.5 to 3%. The loading rates can also be specified in mmol/g of linker groups after functionalization. Typical values are about 0.01 to 10 mmol/g, preferably about 0.05 to 5 mmol/g and most preferred about 0.05 to 2 mmol/g. Specific loading rates that can be mentioned include about 0.08, 0.1, 0.2, 1.0, 1.5, 3.5 and 5 mmol/g.

The grafting step a) is preferably executed by reacting the particles with the polymer chains in the presence of a solvent at elevated temperatures. The solvent can be chosen according to the type of functionalized group that reacts with the polymer according to known reaction conditions. As suitable solvents for linking a halogen alkyl group to the amino or amine groups of the polymer there may be mentioned polar aprotic solvents such as dimethylsulfoxide (DMSO), dimethylformamide (DMF), ethyl acetate, n-methyl pyrrolidone (NMP), dimethylacetamide (DMA), propylene carbonate, and mixtures thereof. In some embodiments, the aprotic, polar solvent is DMSO. Reaction temperatures and times can be also chosen according to the linkage type according to known conditions. For linking a halogen alkyl group to the amino groups of the polymer the reaction is preferably run at temperatures of about 50 to 130° C., more preferably 70 to 110° C. Typical reaction times that can be mentioned then are about 5 to 36 hours, preferably 10 to 24 hours.

The amount of polymer that is reacted in the grafting step can be varied over broader ranges. Typical rates include 1 to 1000 g of polymer, preferably 10 to 100 g and most preferably 15 to 75 g per 1 mmol of linker group on the particle.

The polymer grafted particle is separated by common methods and optionally dried at higher temperatures, such as e.g. about 40 to 80° C. Separation may include filtration as well as repeated washing steps with the solvent.

According to certain embodiments of the invention the polymer grafted particle as the product of step a) can be further reacted with an amphiphilic cyclic carbonate under ring opening to form a urethane bond. The cyclic carbonate may be a substituted cyclic alkylene carbonate, such as substituted trimethylene carbonate. The cyclic carbonate may be functionalized with a quaternary ammonium moiety as cationic group. The quartenary ammonium groups may be linked by alkylene, alkyaryl, arylalkyl or alkylarylalkyl linkers and a C(═O)—O— group to the cyclic carbonate which may be optionally substituted with other substituents, such as for instance alkyl. The moieties of the quaternary ammonium groups or amino groups may further be alkyl or arylalkyl substituents. The cyclic carbonate may therefore be described by general formula (III):

Hal⁻N⁺(R³)-(linker)-O—C(═O)—CAC, [Formula III]

wherein Hal is halogen, N is nitrogen and the R groups are identical or different substituents of the quaternary ammonium group and selected from C₁-C₁₂-alkyl or C₁-C₃-alkyl-phenyl;
the linker is a C₁-C₁₂alkylene group or a C₁-C₃-alkylene-phenyl-C₁-C₃-alkylene group;
and CAC is an optionally substituted cyclic (C₃-C₅-alkylene) carbonate, such as an optionally substituted trimethylene carbonate.

R is preferably C₁-C₈-alkyl or benzyl. The linker is preferably a C₆-C₁₀-alkylene group or a CH₂-phenyl-CH₂— group. The linker is most preferably a C₈-alkylene or CH₂-phenyl-CH₂— group. CAC may preferably a methyl trimethylene carbonate (MTC).

A compound of formula (III) wherein the linker represents a CH₂-phenyl-CH₂— group and at least one R is C₆-C₁₀-alkyl may be specifically mentioned.

In some embodiments the amphiphilic cyclic carbonate is a compound of the following general formulas (IIa) or (IIb):

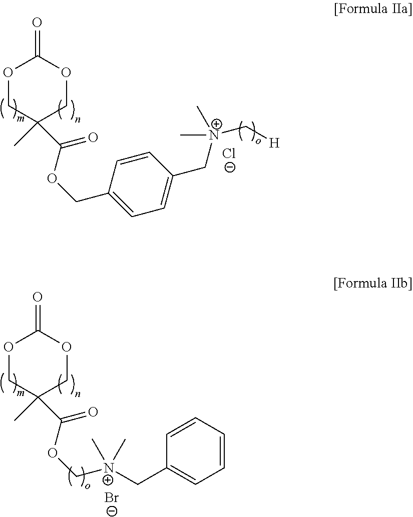

wherein
m is an integer selected from 0, 1 or 2;
n is an integer selected from 0, 1 or 2;
o is an integer selected from 4 to 16.

m may be preferably 1. n may be preferably 1. o may be preferably 6 to 16. It may be however chosen freely from any value such as 5, 6, 7, 8, 9, 10, 11, 12, 13, 14, 15 or 16.

The cyclic carbonate may be selected from MTC-Bn-QA-C8 and MTC-C8-QA-Bn (see working examples).

The cyclic carbamates can be known compounds or can be synthesized from known compounds in accordance with the working examples described or other known methods.

In optional step b) the amphiphilic cyclic carbonates may be grafted onto polyalkylene imine functionalized particles via a one-step ring-opening nucleophilic addition reaction. The reaction is preferably preformed in a solvent under elevated temperatures. As suitable solvents for linking cyclic carbonates to the amino groups of the polymer there may be mentioned polar aprotic solvents such as dimethylsulfoxide (DMSO), dimethylformamide (DMF), ethyl acetate, n-methyl pyrrolidone (NMP), dimethylacetamide (DMA), propylene carbonate, and mixtures thereof. In some embodiments, the aprotic, polar solvent is DMSO. Reaction temperatures and times can be varied. Typically the reaction is run at temperatures of about 30 to 90° C., more preferably 40 to 70° C. Typical reaction times that can be mentioned then are about 5 to 36 hours, preferably 10 to 24 hours.

The reaction may be performed in the presence of a base. Typical bases that can be mentioned include a base selected from the group consisting of KOH, KOCH₃, KO(t-Bu), KH, NaOH, NaO(t-Bu), NaOCH₃, NaH, Na, K, trimethylamine, N,N-dimethylethanolamine, N,N-dimethylcyclohexylamine and higher N,N-dimethylalkylamines, N,N-dimethylaniline, N,N-dimethylbenzylamine, N,N,N′ N′-tetramethylethylenediamine, N,N,N′,N″,N″-pentamethyldiethylenetriamine, imidazole, N-methylimidazole, 2-methylimidazole, 2,2-dimethylimidazole, 4-methylimidazole, 2,4,5-trimethylimidazole and 2-ethyl-4-methylimidazole. Amine bases such as trimethylamine may be preferred.

The polyalkylene imine functionalized particle is reacted with the amphiphilic cyclic carbonate in about equimolar amounts with regard to the available primary amino groups, but preferably the cyclic carbonate is used in molar excess. Step b) can be performed by dissolving the cyclic carbonate in the solvent first and then adding the particles optionally together with the base to the solution.

The further functionalized particle is separated by common methods and optionally dried under vacuum. Separation may include filtration as well as repeated washing steps with aprotic solvents that can wash of any unreacted carbonate, such as dichloromethane (DCM).

The reaction products of step a) and b) are acidified to protonate amine groups in the polymer chains. This leads to more active functionalized particles in water disinfection.

Step c) may be performed using a dilute mineral acid. Typical mineral acids that can be used in diluted form include HCl or H₂SO₄. The polymer-coated particles are usually treated with dilute acid in excess. Incubation with the acid may be 1 to 10 minutes and is optionally supported by sonification. The acidified particles can be separated by known methods and are preferably rinsed with water until the pH is about neutral before storage and use in disinfection.

The particle obtained according to the process of the invention is a novel material and also part of the invention.

According to a third aspect of the invention there is provided the use of the polymer-modified particles according to the invention for removing bacteria from an aqueous solution. The aqueous solution may be preferably contaminated water. Preferably the polymer modified particles are used in acidified form according to process step c). A particle dispersion can be used for disinfection by exposing a bacteria containing medium with the particle dispersion. The particle dispersion can be in an aqueous medium such as water which may be optionally buffered with common buffers, such as PBS buffer. The use of a polymer-modified particle according to the invention for use in water disinfection is therefore another embodiment of the invention. The particles according to the invention show a high effectiveness to combat bacteria selected from Gram-positive and Gram-negative bacteria. S. aureus, P. aeruginosa and E. coli can be mentioned for especially high killing rates.

After the application the particles may be separated off and reused for disinfection. The particles can be separated by common separation techniques. Filtration or centrifugation may be used. A use wherein the particle may be recycled for further use is therefore also part of the invention. According to one embodiment of the invention the particles are rinsed with a polar solvent, preferably an aliphatic alcohol such as methanol, ethanol or isopropanol before reuse.

According to another aspect of the invention a water treatment kit comprising a container of the particles of claim 1 or 16 together with additives or fillers and optionally a container of dilute acid. The additives or fillers can comprise an aqueous buffer medium, pigment, inert compounds or other typical formulation ingredients known in the art. Preferably the kit contains a container with dilute acid. The acid can be used to activate the particles according to the method of step c). The dilute acid is typically a common mineral acid as mentioned above. Equipment to inject the particles or a particle dispersion in bacteria contaminated media and containers for mixing the particle with solvents may also be comprised in the kit.

### EXAMPLES

Non-limiting examples of the invention and a comparative example will be further described in greater detail by reference to specific Examples, which should not be construed as in any way limiting the scope of the invention.

### Materials

Branched PEI with average M_{w} of 25 kDa (Mₙ ˜10 kDa) and 2 kDa (Mₙ ˜1.8 kDa; 50 wt. % in water) were purchased from Sigma-Aldrich Corp. (St. Louis, Mo., U.S.A.) and were freeze-dried before using for polymer grafting on silica surface. 3-Chloropropyl-functionalized silica particles (SiO₂—(CH₂)₃Cl; 230-400 mesh; Cl loading: ˜1.0 mmol/g) used for polymer grafting were purchased from Sigma-Aldrich Corp. Pristine silica particles (SiO₂; 230-400 mesh) were purchased from Merck KGaA (Darmstadt, Germany). All chemical reagents including 4-(chloromethyl)benzyl alcohol, 8-bromo-1-octanol, N,N-dimethyloctylamine and N,N-dimethylbenzylamine from Sigma-Aldrich Corp., and dimethyl sulfoxide (DMSO) and concentrated hydrochloric acid (HCl, 37%) from Merck KGaA were used as received unless otherwise stated. Staphylococcus aureus (S. aureus; ATCC® No. 6538), Pseudomonas aeruginosa (P. aeruginosa; ATCC® No. 9027) and Escherichia coli (E. coli; ATCC® No. 25922™) were purchased from American Type Culture Collection (ATCC; Manassas, Va., U.S.A.) and reconstituted according to standard protocols. Mueller-Hinton broth (MHB) was purchased from BD Diagnostics (Sparks, Md., U.S.A.) and used to prepare the microbial growth medium according to the manufacturer's instructions. Phosphate-buffered saline (PBS, 10×, pH=7.4) was purchased from 1st BASE (Singapore), and Luria broth containing 1.5% agar used for agar plate preparation was obtained from Media Preparation Unit (Biopolis Shared Facilities, A*STAR, Singapore).

### Synthesis of Cyclic Carbonates

Synthesis of MTC-OC₈H₁₆Br

MTC-OC₈H₁₆Br was synthesized with reference to the protocol reported in Pratt, R. C., Nederberg, F., Waymouth, R. M., Hedrick, J. L. Tagging (Alcohols with cyclic carbonate: a versatile equivalent of (meth)acrylate for ring-opening polymerization. Chem. Commun. 2008, 114-116). A solution of oxalyl chloride (2.42 mL, 28.58 mmol) in anhydrous THF (50 mL) was added dropwise over 30 min into a solution of 5-methyl-5-carboxyl-1,3-dioxan-2-one (MTC-OH; 3.08 g, 19.25 mmol) in anhydrous THF (50 mL) containing a catalytic amount (3 drops) of anhydrous DMF under N₂ atmosphere. The solution was stirred for 1 h, bubbled with N₂ flow to remove volatiles, and evaporated under vacuum. The intermediate product 5-chlorocarboxy-5-methyl-1,3-dioxan-2-one (MTC-Cl) was then dissolved in anhydrous DCM (50 mL) and cooled to 0° C. using an ice bath. A solution of 8-bromo-1-octanol (3.21 mL, 17.79 mmol) and pyridine (1.56 mL, 19.22 mmol) in anhydrous DCM (50 mL) was added dropwise over 30 min into the MTC-Cl solution. The reaction mixture was allowed to stir at 0° C. for a further 30 min before it was slowly warmed up to room temperature over 3 h. The solution was rinsed three times with saturated NaCl solution (100 mL), stirred with MgSO₄ overnight, and filtered. Purification of the crude product was carried out by column chromatography on silica gel using gradient elution from hexane to ethyl acetate/hexane (70/30% v/v) to provide MTC-OC₈H₁₆Br as a colorless liquid (Yield, 82%). ¹H NMR (400 MHz, CDCl₃, 22° C.): δ 4.68 (d, 2H, —CH₂OCOO—), 4.19 (m, 4H, —CH₂OCOO— and —OCH₂—), 3.41 (t, 2H, —CH₂Br), 1.85 (m, 2H, —CH₂—), 1.65 (m, 2H, —CH₂—), 1.42 (m, 2H, —CH₂—), 1.32 (s, 9H, —CH₂— and —CH₃).

### Synthesis of MTC-OCH₂BnCl

MTC-OCH₂BnCl was synthesized using a similar procedure as described above with 4-(chloromethyl)benzyl alcohol as the coupling alcohol instead. ¹H NMR (400 MHz, CDCl₃, 22° C.): S 7.36 (dd, 4H, Ph-H), 5.21 (s, 2H, —OCH₂Ph-), 4.69 (d, 2H, —CH₂OCOO—), 4.58 (s, 2H, -PhCH₂Cl), 4.20 (d, 2H, —CH₂OCOO—), 1.32 (s, 3H, —CH₃).

### Synthesis of MTC-Bn-QA-C8 and MTC-C8-QA-Bn

The amphiphilic cyclic carbonates MTC-Bn-QA-C8 and MTC-C8-QA-Bn were synthesized by reacting MTC-OCH₂BnCl and MTC-OC₈H₁₆Br, respectively, with various quaternizing agents. To generate cyclic carbonate with an octyl chain extending from the cationic center, MTC-OCH₂BnCl was quaternized with N,N-dimethyloctylamine to produce MTC-Bn-QA-C8 (FIG. 1). Briefly, MTC-OCH₂BnCl (0.478 g, 1.6 mmol) was dissolved in 10 mL of ACN and N,N-dimethyloctylamine (1.32 mL, 6.4 mmol) was dropped slowly to the solution and reacted overnight. Then, the reaction solution was concentrated to a small volume and precipitated in Et₂O, centrifuged, and washed three times with Et₂O. Finally, the wet solid was dried under vacuum to produce MTC-Bn-QA-C8. ¹H NMR (400 MHz, DMSO-d₆, 22° C.): δ 7.53 (dd, 4H, Ph-H), 5.29 (s, 2H, —OCH₂Ph-), 4.53 (s, 2H, -PhCH₂N^{⊕})—), 4.50 (dd, 4H, —CH₂OCOO—), 3.22 (m, 2H, —N^{⊕}CH₂—), 2.94 (s, 6H, —N^{⊕}(CH₃)₂—), 1.77 (m, 2H, —CH₂—), 1.29 (m, 10H, —CH₂—), 1.28 (s, 3H, —CH₃), 0.88 (t, 3H, —CH₃).

To generate cyclic carbonate with both cationic center and benzyl group positioned at the end of the octyl chain, MTC-OC₈H₁₆Br was quaternized with N,N-dimethylbenzylamine to produce MTC-C8-QA-Bn (FIG. 1). ¹H NMR (400 MHz, DMSO-d₆, 22° C.): δ 7.53 (s, 4H, Ph-H), 4.53 (m, 4H, —CH₂OCOO— and PhCH₂N^{⊕})—), 4.36 (d, 2H, —CH₂OCOO—), 4.14 (t, 2H, —OCH₂—), 3.23 (m, 2H, —N^{⊕}CH₂—), 2.94 (s, 6H, —N^{⊕}(CH₃)₂—), 1.77 (m, 2H, —CH₂—), 1.60 (m, 2H, —CH₂—), 1.31 (m, 8H, —CH₂—), 1.17 (s, 3H, —CH₃).

¹H NMR spectra of the cyclic carbonates were recorded on a Bruker Advance 400 NMR spectrometer at 400 MHz at room temperature. The ¹H NMR measurements were performed with an acquisition time of 3.2 s, a pulse repetition time of 2.0 s, a 30° pulse width, 5208 Hz spectra width, and 32 K data points. Chemical shifts were referenced against the NMR solvent peaks (δ=7.26 and 2.50 ppm for CDCl₃ and DMSO-d₆, respectively).

### Surface Analysis

The surface composition of the pristine, and PEI- and PEI-MTC-coated silica particles was characterized by X-ray photoelectron spectroscopy (XPS) using an AXIS Ultra DLD (delay-line detector) spectrometer equipped with a monochromatic Al Kα source (1486.7 eV) (Kratos Analytical Ltd.; Shimadzu Corp., Japan). The silica particles were mounted onto standard sample holders by means of double-sided adhesive tape. The X-ray power supply was run at 15 kV and 5 mA. The pressure in the analysis chamber during the measurements was typically 10-8 mbar and below. The angle between the sample surface and the detector was kept at 90°. The survey spectrum for each sample ranging from 1100 to 0 eV was acquired. All core level spectra were referenced to the carbon is hydrocarbon peak at 285 eV. In spectra deconvolution, the linewidth (full width half maximum) of the Gaussian peaks was kept constant for all components in a particular spectrum.

To evaluate the amount of polymer coating, thermogravimetric analysis (TGA) was performed on pristine, uncoated, and PEI- and PEI-MTC-coated silica particles using a Pyris 1 TGA instrument (PerkinElmer, Inc., Waltham, Mass., U.S.A.) with standard crucibles and sample sizes of 5-10 mg. The samples were heated at a rate of 5° C./min from room temperature to 900° C. in an air flow of 50 mL/min. During the measurement, air was introduced to the sample to maintain an oxidizing environment and to remove oxidation products.

### Antibacterial Activity

The antibacterial activity of the PEI- and PEI-MTC-coated silica particles was tested against S. aureus, P. aeruginosa and E. coli. First, the bacterial sample was inoculated in MHB at 37° C. with constant overnight shaking at 100 rpm in order to ensure that they entered the log growth phase. The concentration of the bacterial sample was then adjusted to give an initial optical density (O.D.) reading of 0.07 in a 96-well plate measured at a wavelength of 600 nm using a microplate reader (Tecan Group Ltd.; Männedorf, Switzerland), which corresponds to the concentration of McFarland 1 solution (3×10⁸ CFU/mL). The bacterial sample was further diluted to achieve an initial loading of 3×10⁵ CFU/mL. After that, 100 μL of the bacterial sample was added to each well of a 96-well plate, in which 100 μL of polymer-coated silica particles of various concentrations (0-160 mg/mL) was placed. The samples were then incubated at 37° C. with constant shaking at 100 rpm for 18 h, after which 10 μL of the supernatant was extracted from each well, serially diluted in MHB and plated onto an agar plate. Finally, the agar plates were incubated at 37° C. for 18 h, and the number of colony-forming units (CFUs) was counted and compared with the control (bacteria incubated without silica particles). Each test was performed in triplicate.

To examine the killing kinetics of the polymer-coated silica particles, the 96-well plate containing the bacterial sample (100 μL, 3×10⁵ CFU/mL) and the silica sample (100 μL) was prepared and incubated at 37° C. with constant shaking at 100 rpm. At pre-determined time points, 10 μL of the supernatant was extracted, serially diluted and plated onto an agar plate. The number of CFUs was then determined. Each test was performed in triplicate.

To evaluate the antibacterial effectiveness of the polymer-coated silica particles in repeated applications, the bacterial sample (3×10⁸ CFU/mL) was centrifuged, and the supernatant was decanted before being washed three times with PBS. The bacterial sample was further diluted in PBS to achieve an initial loading of 3×10⁵ CFU/mL. The 96-well plate containing the bacterial sample (100 μL, 3×10⁵ CFU/mL) and the silica sample (100 μL) was incubated at 37° C. with constant shaking at 100 rpm for 18 h. The number of CFUs was then determined as described above. Subsequently, the silica sample was centrifuged, washed in distilled water and sonicated in a water bath for 10 min, and the cycle was repeated three times. The particles were then re-suspended in fresh PBS (100 μL) containing an inoculum of bacteria (100 μL, 3×10⁵ CFU/mL), and a new run was initiated.

### EXAMPLES

### Example 1: Synthesis of PEI-Functionalized Silica Particles

Branched PEIs of two molecular weights, mainly 25-kDa and 2-kDa PEI, were separately grafted onto SiO₂—(CH₂)₃Cl particles. PEI (5 g of 25-kDa PEI or 2 g of 2-kDa PEI) was first dissolved in 50 mL of DMSO, and SiO₂—(CH₂)₃Cl particles (0.1 g, 0.1 mmol Cl) were added into the polymer solution. The mixture was stirred continuously at 90° C. for 18 h (FIG. 2). The polymer-coated silica particles were rinsed repeatedly with DMSO and followed by water for three times in order to remove unreacted polymer before being dried at 60° C. To protonate the amine groups of the surface-grafted PEI, the polymer-coated silica particles were treated with dilute HCl in excess and incubated in the presence of sonication for 5 min. The acidified particles were then rinsed repeatedly with water until the pH is close to neutral (i.e., pH=7).

### Example 2: Synthesis of PEI-MTC-Functionalized Silica Particles

The amphiphilic cyclic carbonates were grafted onto PEI-coated silica particles via a one-step ring-opening nucleophilic addition reaction. For 25-kDa-PEI-coated silica particles, MTC-Bn-QA-C8 (273 mg) or MTC-C8-QA-Bn (292 mg) was first dissolved in 2 mL of DMSO, before adding PEI-coated silica particles (0.1 g) and trimethylamine (167 μL) into the solution. For 2-kDa-PEI-coated silica particles, MTC-Bn-QA-C8 (253 mg) or MTC-C8-QA-Bn (270 mg) was first dissolved in 2 mL of DMSO, before adding PEI-coated silica particles (0.1 g) and trimethylamine (155 μL) into the solution. In both cases, the cyclic carbonate was added in excess with respect to the primary amine groups of PEI. The mixture was left to stir continuously at 60° C. for 18 h. After 18 h, the PEI-MTC-coated silica particles were rinsed repeatedly with DCM for three times in order to remove unreacted carbonates before being dried in vacuo. To protonate the amine groups of the surface-grafted PEI, the PEI-MTC-coated silica particles were then treated with dilute acid as described above.

### Results

According to the examples silica particles grafted with PEI or PEI modified with MTC have been prepared and characterized their antimicrobial properties have been determined. The synthetic approach of producing PEI-coated silica particles involved: (i) reacting the primary amine groups of PEI (i.e., terminal groups) with the propyl chloride groups of SiO₂—(CH₂)₃Cl particles, and (ii) acidifying the surface-grafted PEI to introduce quaternary ammonium groups. To produce PEI-MTC-coated silica particles, it involved: (i) synthesis of amphiphilic cyclic carbonates consisting of quaternary ammonium group and alkyl chain, and reacting the primary amine groups of PEI with these carbonates, and (ii) acidifying the surface-grafted PEI-MTC as before.

The synthesis of these amphiphilic cyclic carbonates with 5-methyl-5-carboxyl-1,3-dioxan-2-one (MTC-OH) was performed. In order to design antimicrobial carbonates with reactive moieties towards tertiary amines for quaternization, cyclic carbonates with benzyl chloride functional group (MTC-OCH₂BnCl) or alkyl bromide functional group (e.g., MTC-OC₈H₁₆Br with a octyl chain) were synthesized (see cf. Pratt, R. C., Nederberg, F., Waymouth, R. M., Hedrick, J. L. Tagging, alcohols with cyclic carbonate: a versatile equivalent of (meth)acrylate for ring-opening polymerization. Chem. Commun. 2008, 114-116). These cyclic carbonates with reactive pendant groups can undergo a straightforward quaternization with various tertiary amines under mild conditions. Specifically, MTC-OCH₂BnCl cyclic carbonate was quaternized with N,N-dimethyloctylamine to produce MTC-Bn-QA-C8 consisting of an octyl chain extending from the cationic center. MTC-OC₈H₁₆Br cyclic carbonate was quaternized with dimethylbenzylamine to produce MTC-C8-QA-Bn consisting of a cationic center with a benzyl group positioned at the end of the octyl chain. In the examples the pendant group of MTC-C8-QA-Bn is a mirror image of that of MTC-Bn-QA-C8. The chemical structures and compositions of these amphiphilic cyclic carbonates were verified against ¹H NMR spectra, and all peaks attributed to the MTC-OCH₂BnCl and N,N-dimethyloctylamine were clearly observed.

According to example 1, molecular weights of PEI, mainly 25-kDa and 2-kDa PEI, were separately grafted onto SiO₂—(CH₂)₃Cl particles. The particles had sizes ranging from 40-63 μm with a Cl loading of 1 mmol/g. To produce PEI-coated silica particles, the primary amine group of PEI was allowed to react with the propyl chloride group on silica surface (FIG. 2). To impart antimicrobial properties to the PEI-coated silica particles, the non-protonated amine groups of the surface-grafted PEI were acidified by HCl to introduce quaternary ammonium groups (FIG. 2). In this way, the protonated ammonium groups of the surface-grafted PEI are cationic, while the non-protonated amine groups and ethylene backbone serve as hydrophobic groups, which create repeating cationic amphiphilic structures along the polymer backbone at neutral pH without any further chemical modification by hydrophobic groups.

According to example 2, a series of amphiphilic cyclic carbonates as described were grafted onto PEI-coated silica particles. The ratio of primary, secondary and tertiary amine groups of branched PEI is ca. 25%, 50% and 25%. The theoretical ratio of the amines is usually assumed in this art. To produce PEI-MTC-coated silica particles, the amphiphilic cyclic carbonate (MTC-Bn-QA-C8 or MTC-C8-QA-Bn) was allowed to react with the primary amine group of PEI via a one-step ring-opening nucleophilic addition, resulting in the formation of a stable urethane linker (FIG. 2). In order to achieve high conversion, the reaction mixture was stirred at 60° C. for at least 18 h. The PEI-MTC-coated silica particles were subsequently acidified to quaternize the non-protonated amine groups in the surface-grafted PEI-MTC so as to impart antibacterial properties (FIG. 2).

XPS measurements were performed on the PEI- and PEI-MTC-coated silica particles before and after acidification. FIG. 3 shows the carbon is core level spectra of the pristine, and PEI- and PEI-MTC-coated silica particles based on different molecular weights of PEIs before acidification. The binding energy range in the high-resolution carbon is spectra is about 283-290 eV, and the spectra of the PEI- and PEI-MTC-coated silica particles can be fitted with different component peaks. For C—C/C—H bonding, the carbon is binding energy value is equal to 284.5 eV. As compared to the pristine SiO₂ particles, both SiO₂-25kPEI-Non-Acidified and SiO₂-2kPEI-Non-Acidified particles showed two additional peaks at ˜286 eV and ˜287 eV which corresponded to C—NHR bond in amine groups of PEI and unreacted C—Cl bond in propyl chloride group of SiO₂—(CH₂)₃Cl, respectively (FIGS. 3b and 3e). On the other hand, the deconvoluted peaks for PEI-MTC-coated silica particles showed functional groups of C—C/C—H, C—O and C—NHR, C—N and C—Cl, and C═O at ˜284.5, 286, 287 and 289 eV, respectively, with contribution(s) arising from PEI and/or carbonate (FIGS. 1c-1d and 1f-1g). The peaks at 287 and 289 eV confirm the formation of the urethane linker between PEI and MTC (FIG. 2). Overall, these observed peaks suggest that PEI and MTC were successfully grafted onto the silica surface.

FIG. 4 shows the nitrogen is core level spectra of the PEI- and PEI-MTC-coated silica particles based on different molecular weights of PEIs before and after acidification. Both PEI- and PEI-MTC-coated silica particles exhibited two predominant peaks observed at ˜399 and 401 eV, attributable to the N—H functional group and the positively-charged nitrogen of quaternary ammonium group, respectively. By acidifying the surface-grafted PEI, both SiO₂-25kPEI-Acidified and SiO₂-2kPEI-Acidified particles showed a significant increase in surface [N⁺]/[N] ratio from 0.26 to 0.62 and 0.23 to 0.74, respectively (Table 1). This observation indicates that acid treatment is an effective method in protonating the amine groups of the surface-grafted PEI and enhancing its antibacterial efficacy. However, the acidification of the surface-grafted 25-kDa-PEI-MTC resulted in minimal or no increase in surface [N⁺]/[N] ratio (Table 1). While the SiO₂-25kPEI-MTC-C8-QA-Bn-Acidified particles showed a slight increase in surface charge from 0.29 to 0.39, the SiO₂-25kPEI-MTC-Bn-QA-C8-Acidified particles maintained the surface charge at 0.34. In contrast, the acidification of the surface-grafted 2-kDa-PEI-MTC showed a surface [N⁺]/[N] ratio approaching to that of the SiO₂-2kPEI-Acidified particles. Specifically, the SiO₂-2kPEI-MTC-Bn-QA-C8-Acidified and SiO₂-2kPEI-MTC-C8-QA-Bn-Acidified particles showed a significant increase in surface charge from 0.41 to 0.77 and 0.26 to 0.62, respectively. The disparity between the two cases may be attributed to the difference in efficiency of the acidification step for 25-kDa-PEI-MTC and 2kDa-PEI-MTC. With the incorporation of the amphiphilic carbonate, the hydrophobicity of the surface-grafted PEI-MTC increases due to the presence of the alkyl chain, thereby improving its propensity to penetrate the bacterial membrane. At the same time, the cationic groups present in the PEI/carbonate would make them highly accessible to bacterial cells, and together with the hydrophobic alkyl chain, would make them highly bactericidal.

[Table 1] shows the surface composition of PEI- and PEI-MTC-coated silica particles before and after acidification.

TABLE 1

| | | PEI content^{b} | MTC content^{b} |
|---|---|---|---|
| | Surface | (mg/mg of | (mg/mg of |
| Samples | [N⁺]/[N] ratio^{a} | SiO₂—(CH₂)₃Cl) | SiO₂-PEI) |
| SiO₂-25kPEI-Non-Acidified | 0.26 | 0.122 | — |
| SiO₂-25kPEI-MTC-Bn-QA-C8-Non- | 0.34 | — | 0.154 |
| Acidified | | | |
| SiO₂-25kPEI-MTC-C8-QA-Bn-Non- | 0.29 | — | 0.179 |
| Acidified | | | |
| SiO₂-25kPEI-Acidified | 0.62 | — | — |
| SiO₂-25kPEI-MTC-Bn-QA-C8-Acidified | 0.34 | — | — |
| SiO₂-25kPEI-MTC-C8-QA-Bn-Acidified | 0.39 | — | — |
| SiO₂-2kPEI-Non-Acidified | 0.23 | 0.139 | — |
| SiO₂-2kPEI-MTC-Bn-QA-C8-Non- | 0.41 | — | 0.118 |
| Acidified | | | |
| SiO₂-2kPEI-MTC-C8-QA-Bn-Non- | 0.26 | — | 0.146 |
| Acidified | | | |
| SiO₂-2kPEI-Acidified | 0.74 | — | — |
| SiO₂-2kPEI-MTC-Bn-QA-C8-Acidified | 0.77 | — | — |
| SiO₂-2kPEI-MTC-C8-QA-Bn-Acidified | 0.62 | — | — |

^{a}Data obtained from XPS;
^{b}Data obtained from TGA.

The PEI and PEI-MTC coatings were verified by TGA, and the TGA curves for pristine, uncoated, and PEI- and PEI-MTC-coated silica particles are shown in FIG. 5. The TGA curve for pristine silica particles exhibited a two-stage profile consisting of an initial loss in physisorbed water (30-130° C.), followed by dehydroxylation of silica at higher temperatures. The uncoated SiO₂—(CH₂)₃Cl particles displayed a higher mass loss between 250 and 900° C. due to thermal degradation of the propyl chloride bonds on silica surface. The PEI- and PEI-MTC-coated silica particles showed a three-stage degradation profile: (i) loss in physisorbed water (30-130° C.), (ii) degradation of PEI and/or PEI-MTC and urethane bonds, and (iii) degradation of propyl chloride bonds and dehydroxylation of silica at higher temperatures. PEI of 25-kDa was reported to show a maximum degradation at about 360° C., while poly(trimethylene carbonate) showed degradation between 200 and 300° C. The PEI content constituting SiO₂—PEI particles could be readily calculated by subtracting the total mass loss of SiO₂—(CH₂)₃Cl particles from that of SiO₂—PEI particles. A similar method could be employed to calculate the MTC content constituting SiO₂—PEI-MTC particles. This method of quantification excludes the weight loss contribution from any adsorbed moisture. In this manner, the calculated PEI contents for SiO₂-25kPEI and SiO₂-2kPEI particles are ˜0.122 and 0.139 mg/mg of SiO₂—(CH₂)₃Cl, respectively (Table 1). The MTC-Bn-QA-C8 and MTC-C8-QA-Bn contents for SiO₂-25kPEI-MTC particles are ˜0.154 and 0.179 mg/mg SiO₂-25kPEI, respectively, which corresponded to ˜48 and 52% of primary amine groups of PEI reacted with cyclic carbonate (Table 1). Moreover, the MTC-Bn-QA-C8 and MTC-C8-QA-Bn contents for SiO₂-2kPEI-MTC particles are ˜0.118 and 0.146 mg/mg SiO₂-2kPEI, respectively, which corresponded to ˜34 and 39% of primary amine groups of PEI reacted with cyclic carbonate (Table 1). The similar reactivity of the two amphiphilic cyclic carbonates towards 25kDa- and 2kDa-PEI allows a straightforward functionalization of the surface-grafted PEI.

### Antibacterial Efficacy of PEI- and PEI-MTC-Functionalized Silica Particles

The PEI- and PEI-MTC-coated silica particles were tested for their antibacterial activity in solution regarding the effects of (i) the molecular weight of PEI, (ii) the hydrophilic/hydrophobic balance of the surface-grafted PEI resulting from acidification and MTC modification, and (iii) the cationic and hydrophobic pendant group structure of the carbonate in the surface-grafted PEI-MTC. FIG. 6 shows the number of remaining viable bacterial colonies following incubation with varying amounts of PEI- and PEI-MTC-coated silica particles based on 25-kDa PEI. SiO₂-25kPEI-Non-Acidified particles were ineffective in inhibiting bacterial growth except when using a high particle concentration of 160 mg/ml against S. aureus (FIG. 6a). However, upon acidification, the particles showed a significant improvement in antibacterial activity against S. aureus and P. aeruginosa. In particular, SiO₂-25kPEI-Acidified particles eradicated S. aureus colonies in the solution completely at 40 mg/mL, while achieving more than three-logarithm reduction (99.9% kill) in P. aeruginosa colonies at the same particle concentration (FIGS. 6a and 6b). While the SiO₂-25kPEI-Acidified particles remained ineffective against E. coli, both SiO₂-25kPEI-MTC-Bn-QA-C8-Acidified and SiO₂-25kPEI-MTC-C8-QA-Bn-Acidified particles eliminated the bacterial colonies completely at 160 mg/mL (FIG. 6c). Though the SiO₂-25kPEI-MTC-Acidified particles (10 mg/mL) showed higher antibacterial efficacy against S. aureus than the SiO₂-25kPEI-Acidified particles (40 mg/mL), their activity against P. aeruginosa was compromised (FIGS. 6a and 6b).

FIG. 7 shows the corresponding antibacterial results for the PEI- and PEI-MTC-coated silica particles based on 2-kDa PEI. As compared to SiO₂-25kPEI-Acidified particles, the SiO₂-2kPEI-Acidified particles showed high antibacterial efficacies against all bacterial types, particularly against S. aureus and P. aeruginosa, implying the importance of molecular size of PEI on the antibacterial activity. In particular, the SiO₂-2kPEI-Acidified particles eradicated S. aureus colonies completely at 10 mg/mL, while achieving more than three-logarithm reduction in P. aeruginosa colonies at the same particle concentration (FIGS. 7a and 7b). However, a high particle concentration of SiO₂-2kDa-Acidified was needed to be effective against E. coli (FIG. 5c). Branched PEIs seem to have significantly higher MIC (minimum inhibitory concentration) values for E. coli than those for S. aureus. Upon MTC modification, it was observed that the SiO₂-2kPEI-MTC-Bn-QA-C8-Acidified particles eradicated S. aureus, P. aeruginosa and E. coli colonies completely at 10, 40 and 40 mg/mL, respectively, with significant improvement in antibacterial efficacy against E. coli as compared to the SiO₂-2kDa-Acidified particles (FIG. 7). However, SiO₂-2kPEI-MTC-C8-QA-Bn-Acidified particles showed reduced and even no antibacterial activity against P. aeruginosa and E. coli, respectively (FIGS. 7b and 7c). The disparity in efficacies suggests the dependency of the pendant group structure of carbonate on the antibacterial activity, and therefore, 2kPEI-MTC-Bn-QA-C8-Acidified can render higher accessibility to bacteria and potent antibacterial activity than 2kPEI-MTC-C8-QA-Bn-Acidified.

### Killing Kinetics of PEI- and PEI-MTC-Functionalized Silica Particles

The particles that exhibited excellent antibacterial efficacies were SiO₂-25kPEI-Acidified, SiO₂-2kPEI-Acidified and SiO₂-2kPEI-MTC-Bn-QA-C8-Acidified particles, and they were further assessed for their killing kinetics against S. aureus, P. aeruginosa and E. coli (FIG. 8). For S. aureus, SiO₂-25kPEI-Acidified particles (40 mg/mL) showed similar killing kinetics as SiO₂-2kPEI-Acidified particles (10 mg/mL) with complete elimination after ˜2 h of treatment (FIG. 8a). For P. aeruginosa, SiO₂-2kPEI-Acidified particles (40 mg/mL) eradicated the bacterial cells at a faster rate than SiO₂-25kPEI-Acidified particles (80 mg/mL) with complete elimination after ˜1 h of treatment (FIG. 8b). For E. coli, SiO₂-2kPEI-MTC-Bn-QA-C8-Acidified particles (40 mg/mL) eliminated the bacterial cells completely after ˜2 h of treatment (FIG. 8c).

### Repeated Applications of PEI- and PEI-MTC-Functionalized Silica Particles

The antibacterial efficacies of PEI- and PEI-MTC-coated silica particles in repeated applications against S. aureus, P. aeruginosa and E. coli were also investigated (FIG. 9). The SiO₂-2kPEI-Acidified and SiO₂-2kPEI-MTC-Bn-QA-C8-Acidified particles could offer at least two times of reusability with more than 99% antibacterial efficacy against S. aureus and E. coli, respectively. However, the SiO₂-2kPEI-Acidified particles showed a decrease in antibacterial efficacy in the third application against P. aeruginosa. Bacterial cells can adsorb on solid surfaces by electrostatic or hydrophobic interaction, or both. The decrease in bactericidal activity may be attributed to the accumulation of dead cell debris on the silica surface, which subsequently reduces the interaction of the PEI or PEI-MTC with bacterial cells in the next application. This problem may be mitigated by washing the particles thoroughly with ethanol before exposing to a new bacterial culture.

According to the examples a facile method for the preparation of antimicrobial silica particles functionalized with PEI or PEI modified with amphiphilic cycle carbonates consisting of quaternary ammonium groups and hydrophobic alkyl chains through a facile ring-opening reaction. The molecular size of PEI may play an important role in affecting the antibacterial activity. The SiO₂-2kPEI-Acidified particles displayed higher antibacterial efficacies against all bacterial types than the SiO₂-25kPEI-Acidified particles. Moreover, the pendant group structure of carbonate also influenced the antibacterial activity, and in particular, upon modification with MTC-Bn-QA-C8, the SiO₂-2kPEI-MTC-Bn-QA-C8-Acidified particles rendered excellent broad-spectrum antibacterial efficacies at a low particle concentration. Lastly, the SiO₂-2kPEI-Acidified and SiO₂-2kPEI-MTC-Bn-QA-C8-Acidified particles exhibited rapid killing rates, and their antibacterial properties were preserved even after repeated applications using the same batch of particles. All PEI- and PEI-MTC-coated silica particles hold great potential for use in water disinfection without the need for chemical treatment.

### DESCRIPTION OF DRAWINGS

The accompanying drawings illustrate a disclosed embodiment or reaction scheme and serve to explain the principles of the disclosed embodiments. It is to be understood, however, that the drawings are designed for purposes of illustration of examples only, and not as a limitation of the invention.

FIG. 1 is a schematic drawing of the synthesis of amphiphilic cyclic carbonates consisting of different pendant group structures.

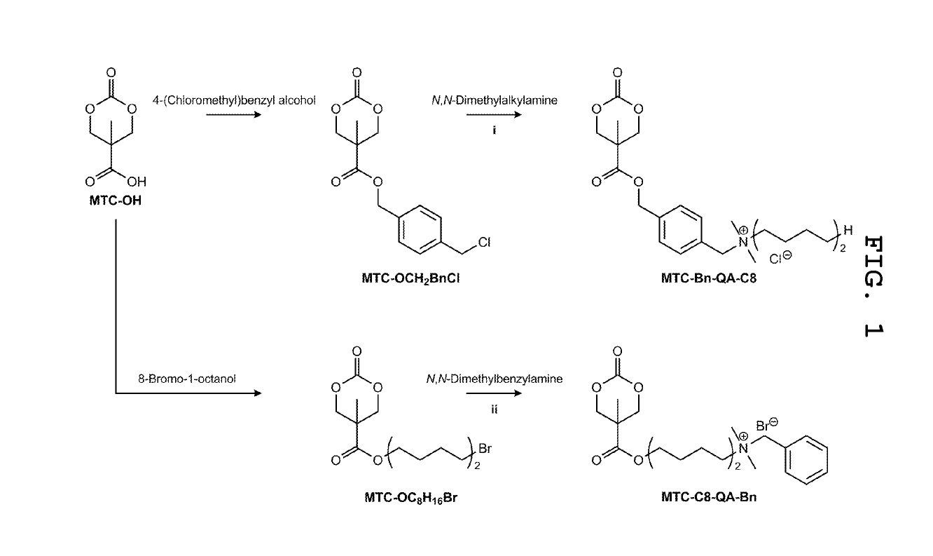

FIG. 2 is a schematic drawing of the synthesis of PEI- and PEI-MTC-functionalized silica particles.

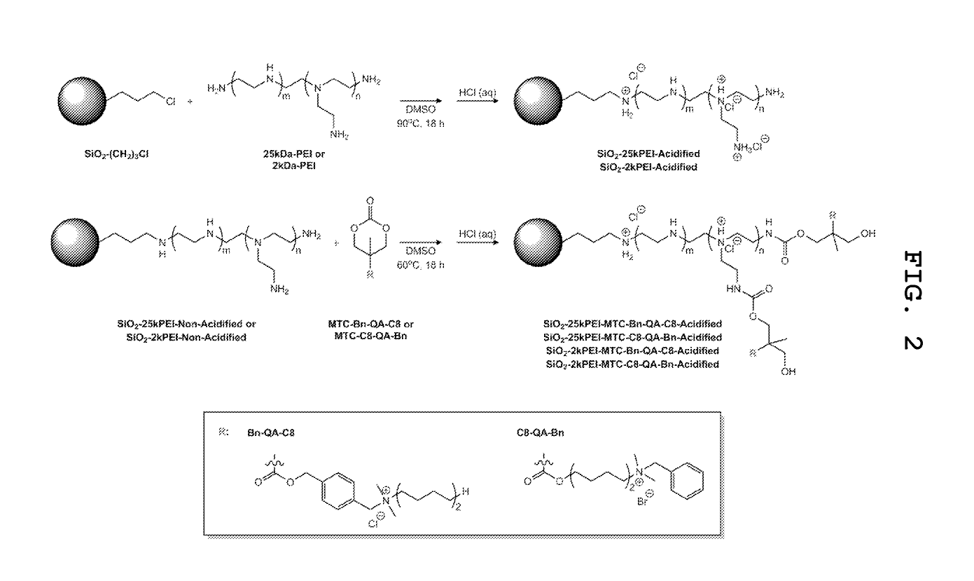

FIG. 3 shows carbon is core level spectra of (a) pristine, and (b, e) PEI- and (c-d and f-g) PEI-MTC-coated silica particles. (b-d) and (e-g) correspond to 25kDa- and 2kDa-coated silica particles, respectively. For PEI-coated silica particles, the red, green and blue peaks are associated with the C—C/C—H bonded carbon (˜284.5 eV), C—NHR bonded carbon (˜286.0 eV) and C—Cl bonded carbon (˜287.0 eV), respectively. For PEI-MTC-coated silica particles, the red, green, blue and yellow peaks are associated with the C—C/C—H bonded carbon (˜284.5 eV), C—O and C—NHR bonded carbon (˜286.0 eV), C—N and C—Cl bonded carbon (˜287.0 eV) and C═O bonded carbon (˜289.0 eV), respectively.

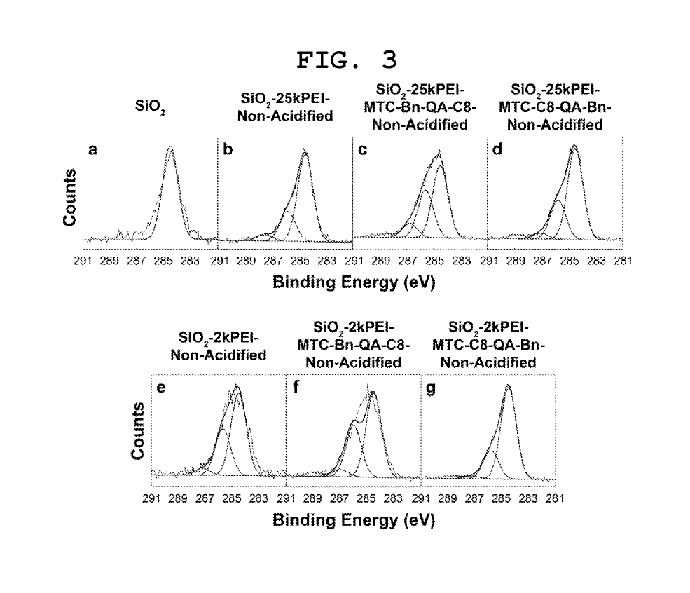

FIG. 4 shows nitrogen is core level spectra of (a, d) PEI- and (b-c and e-f) PEI-MTC-coated silica particles before and after acidification. (i) and (ii) correspond to PEI- or PEI-MTC-coated silica particles based on 25-kDa and 2-kDa PEI, respectively. Red and green peaks are associated with the NH bonded nitrogen (˜399.0 eV) and quaternary ammonium bonded nitrogen (˜401.0 eV), respectively.

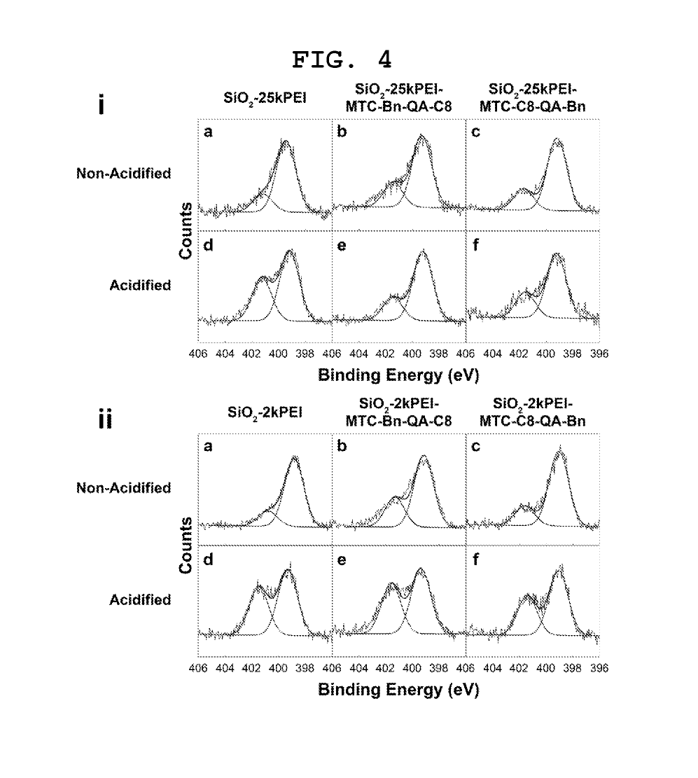

FIG. 5 shows TGA curves for pristine, uncoated, and PEI- and PEI-MTC-coated silica particles. (a) and (b) correspond to PEI- or PEI-MTC-coated silica particles based on 25-kDa and 2-kDa PEI, respectively.

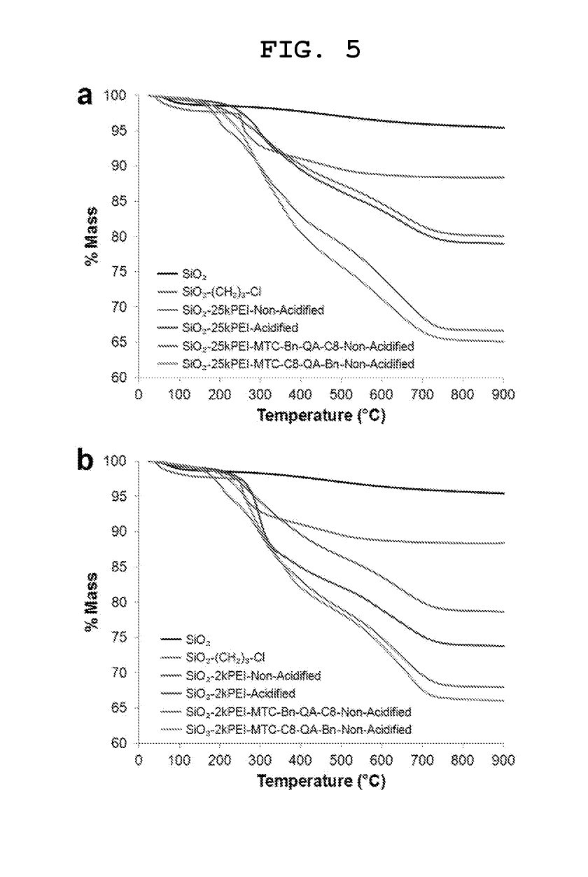

FIG. 6 shows the antimicrobial efficacy of varying amounts of PEI- and PEI-MTC-coated silica particles based on 25-kDa PEI against (a) S. aureus, (b) P. aeruginosa, and (c) E. coli, with initial bacterial count of 3×105 CFU/mL and incubated at 37° C. for 18 h. An aliquot of the medium serially diluted was plated onto agar plates to assess microorganism survival. The control experiment (black column) was conducted by having a cell suspension without silica particles. White or patterned circle indicates no colony observed. Data corresponds to mean±standard deviation (n=3).

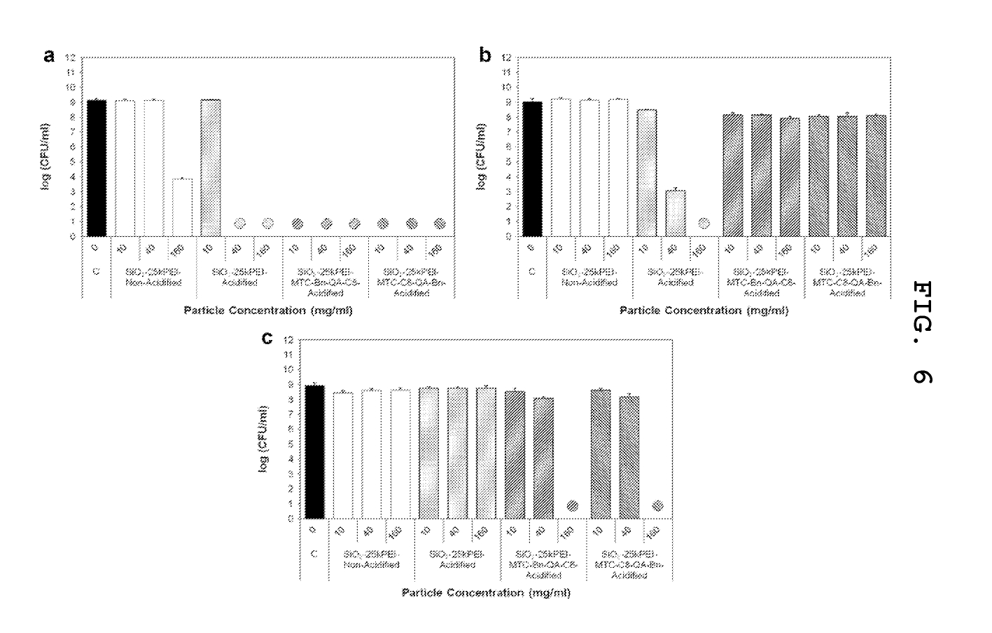

FIG. 7 shows the antimicrobial efficacy of varying amounts of PEI- and PEI-MTC-coated silica particles based on 2-kDa PEI against (a) S. aureus, (b) P. aeruginosa, and (c) E. coli, with initial bacterial count of 3×105 CFU/mL and incubated at 37° C. for 18 h. An aliquot of the medium serially diluted was plated onto agar plates to assess microorganism survival. The control experiment (black column) was conducted by having a cell suspension without silica particles. White or patterned circle indicates no colony observed. Data corresponds to mean±standard deviation (n=3).

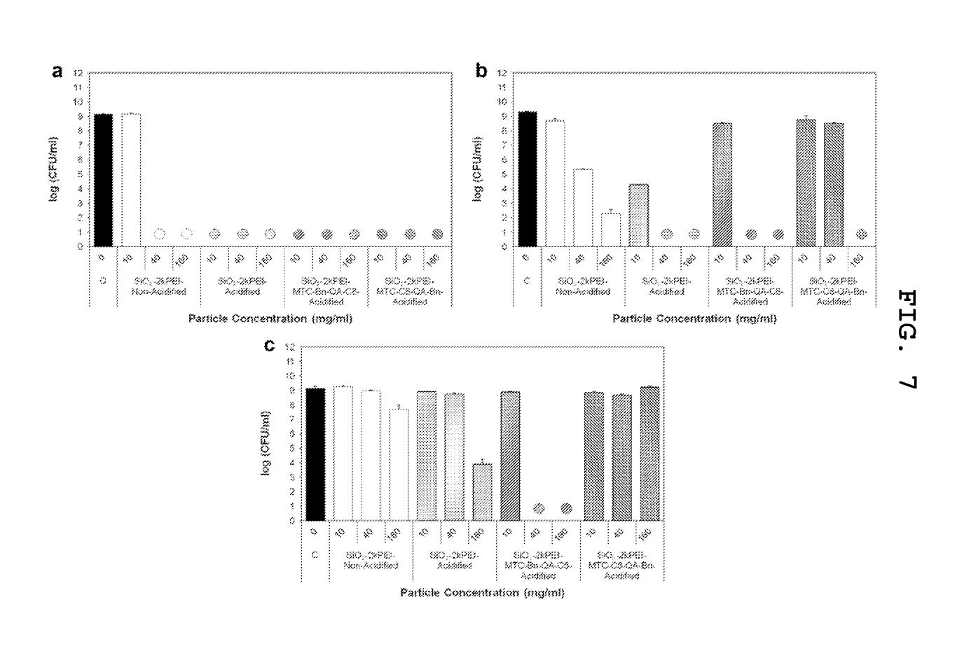

FIG. 8 shows the time course of bacterial killing of (a) S. aureus, (b) P. aeruginosa, and (c) E. coli with initial bacterial count of 3×105 CFU/mL by varying amounts of PEI- and PEI-MTC-coated silica particles. An aliquot of the medium serially diluted was plated onto agar plates to assess microorganism survival. The control experiment (black column) was conducted by having a cell suspension without silica particles. Data corresponds to mean±standard deviation (n=3).

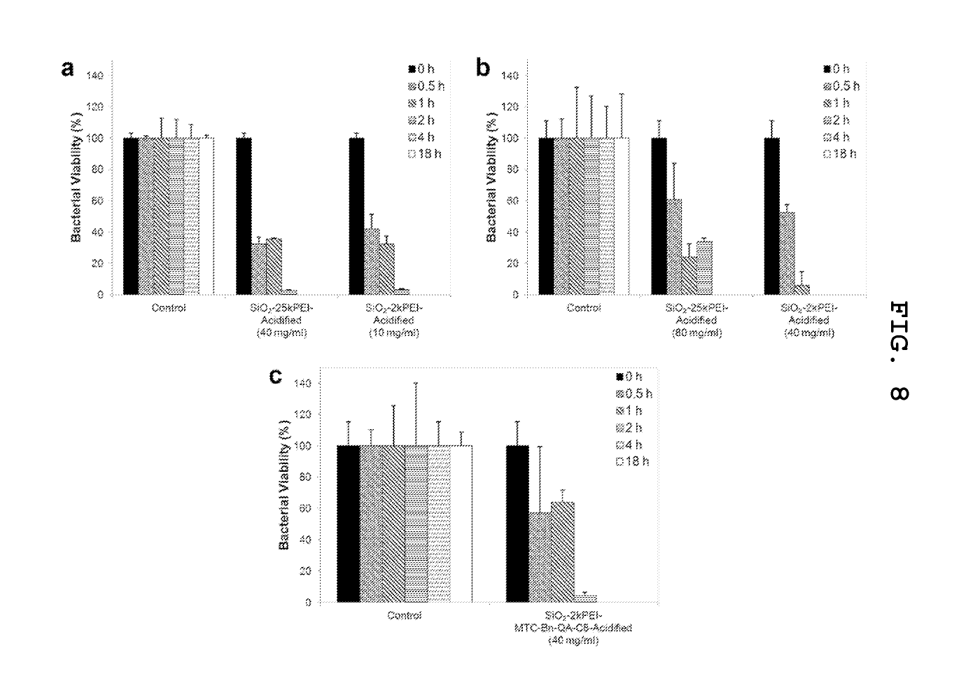

FIG. 9 shows the result of repeated antibacterial assays of the PEI- and PEI-MTC-coated silica particles. The particles were incubated with bacterial cells (3×105 CFU/mL) in PBS at 37° C. for 18 h. An aliquot of the medium serially diluted was plated onto agar plates to assess microorganism survival. Subsequently, the particles were centrifuged, washed and sonicated repeatedly in water for three times. The particles were then re-suspended in fresh PBS containing an inoculum of bacterial cells (3×105 CFU/mL), and a new run was initiated. Data corresponds to mean±standard deviation (n=3).

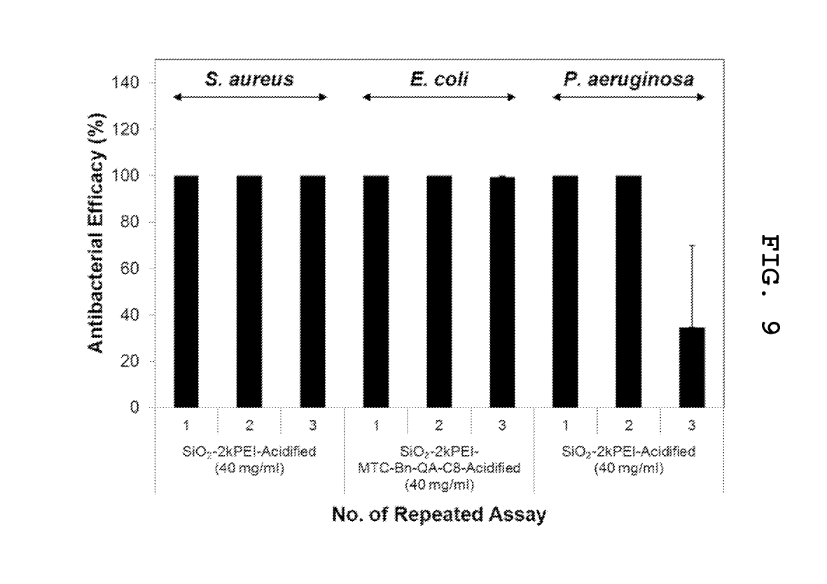

### INDUSTRIAL APPLICABILITY

The polymer-modified particles according to the first aspect of the invention exert strong and broad-spectrum antibacterial activity. They are susceptible to mass production and scale up for water disinfection applications while avoiding the need for chemical treatment. The can also be recycled after use.

The polymer-modified particles may replace common anti-microbial in applications where a non-chemical, mild killing of bacteria, especially in contaminated water, is desired.

It will be apparent that various other modifications and adaptations of the invention are available to the person skilled in the art after reading the foregoing disclosure without departing from the spirit and scope of the invention and it is intended that all such modifications and adaptations come within the scope of the appended claims.

1.-25. (canceled)

26. An antibacterial polymer-modified particle comprising a particle core, wherein a polymer is covalently bound to the particle core via a linker and said polymer comprises a branched, amphiphilic cationic polyalkylene imine backbone having amine or amino functional groups, wherein the particle has been activated by pre-treatment with an acid to increase the amount of protonated ammonium groups.

27. The polymer-modified particle of claim 26, wherein all or some of the amine or amino groups of the polymer have been further reacted with amphiphilic cyclic carbonates carrying a cationic group under formation of a urethane bond or before the acidic pre-treatment.

28. The compounds of claim 27 wherein the cationic group of the amphiphilic cyclic carbonate is a quaternary ammonium group.

29. The polymer-modified particle of claim 26, wherein the particle core is a silica core.

30. The polymer-modified particle of claim 26, wherein the cationic backbone is a polyethylenimine (PEI) moiety.

31. The polymer-modified particle of claim 26, wherein the cationic backbone is a polyalkylene imine moiety with a molecular weight range of about 1 kDa to about 30 kDa, preferably about 1.2 to 3 kDa.

32. The polymer-modified particle of claim 26, wherein the optional urethane bond linked unit can be represented by general formula (Ia) or (Ib) 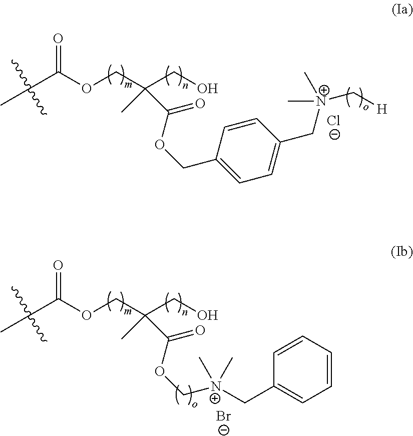
wherein
m is an integer selected from 0, 1 or 2; and is preferably 1;
n is an integer selected from 0, 1 or 2; and is preferably 1; and
o is an integer selected from 4 to 16, preferably 6 to 10.

33. The polymer-modified particle of claim 26, wherein the linker comprises an optionally substituted alkyl moiety, preferably a propyl group.

34. The polymer-modified particle of claim 33, wherein the linker is covalently bound to the cationic backbone via an amine bridge.

35. A method for making a polymer-modified particle, comprising:
a) grafting a branched, amphiphilic cationic polyalkylene imine backbone polymer to a particle, which has been surface functionalized with a linker,
b) optionally reacting the product of operation a) with an amphiphilic cyclic carbonate under ring opening to form a urethane bond and c) acidifying the reaction product of operation a) or b) with an acid to form the amphiphilic cationic backbone,
wherein the polymer-modified particle comprises an antibacterial polymer-modified particle comprising a particle core,
wherein a polymer is covalently bound to the particle core via a linker and said polymer comprises a branched, amphiphilic cationic polyalkylene imine backbone having amine or amino functional groups, wherein the particle has been activated by pre-treatment with an acid to increase the amount of protonated ammonium groups.

36. The method of claim 35 wherein the polymeric backbone is a polyethylenimine (PEI) unit with a molecular weight range of about 1 kDa to about 30 kDa, preferably about 1.2 to 3 kDa.

37. The method of claim 35 wherein the particle of operation a) is functionalized with an alkyl halogen moiety, preferably a propyl chloride or propyl bromide group.

38. The method of claim 35 wherein the particle is of a size of 40 μm to 1 cm.

39. The method of claim 35, wherein the amphiphilic cyclic carbonate is functionalized with a quaternary ammonium moiety.

40. The method of claim 35, wherein the amphiphilic cyclic carbonate is a compound of formula (III)
Hal⁻N⁺(R³)-(linker)-O—C(═O)—CAC [Formula III]
wherein Hal is halogen, N is nitrogen and the R groups are identical or different substituents of the quaternary ammonium group and selected from C₁-C1₂-alkyl or C₁-C₃-alkyl-phenyl;
the linker is a C₁-C₁₂-alkylene group or a C₁-C₃-alkylene-phenyl-C₁-C₃-alkylene group; and
CAC is an optionally substituted cyclic (C₃-C₅-alkylene) carbonate, such as an optionally substituted trimethylene carbonate.

41. The method of claim 40, wherein the linker is a C₁-C₃-alkylene-phenyl-C₁-C₃-alkylene group and at least one R group is C₅-C₁₀-alkyl.

42. The method of claim 39, wherein the amphiphilic cyclic carbonate is a compound of the following general formulas (IIa) or (IIb): 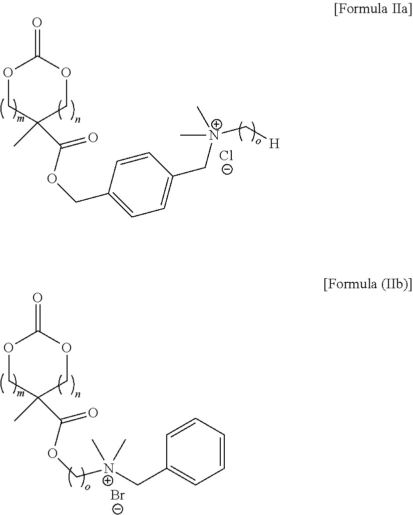
wherein
m is an integer selected from 0, 1 or 2;
n is an integer selected from 0, 1 or 2;
o is an integer selected from 4 to 16.

43. The method of claim 42, wherein in formula (IIa) o is selected from 6 to 8.

44. The method of claim 35, wherein the acidification of operation c) is performed using a dilute mineral acid, such as hydrochloric acid.

45. A water treatment kit comprising a container of particles together with additives or fillers and optionally a container of dilute acid, wherein each of the particles comprises an antibacterial polymer-modified particle comprising a particle core,
wherein a polymer is covalently bound to the particle core via a linker and said polymer comprises a branched, amphiphilic cationic polyalkylene imine backbone having amine or amino functional groups, wherein the particle has been activated by pre-treatment with an acid to increase the amount of protonated ammonium groups.
